(19) United States
(12) Patent Application Publication
(10) Pub. No.: US 2011/0070354 A1
(43) Pub. Date: Mar. 24, 2011

(54) Instantized whey protein concentrate/isolate with egg lecithin

(76) Inventor: Alex Rogers, Brick, NJ (US)

(21) Appl. No.: 12/807,879

(22) Filed: Sep. 16, 2010

Related U.S. Application Data
(60) Provisional application No. 61/277,167, filed on Sep. 22, 2009.

(51) Int. Cl. A23J 3/08; A23J 7/00

(52) U.S. Cl. 426/648

(57) ABSTRACT

A liquid soluble protein drink comprised of whey protein concentrate or whey protein isolate in combination with egg lecithin which results in a protein supplement wherein the whey protein concentrate is 80% protein and the whey protein isolate is 90% protein when combined with egg lecithin and eliminating phytosterols.

### RELATED APPLICATIONS

Applicant claims the benefit of provisional application Ser. No. 61/277,167, filed Sep. 22, 2009.

### BACKGROUND OF THE INVENTION

1. Field of the Invention

The present invention relates to protein supplements, and in particular, a liquid soluble protein supplement formulated of whey protein concentrate or whey protein isolate with egg lecithin.

2. Description of the Prior Art

Whey protein powder is the preferred protein powder for use as a protein supplement. It contains a high amount of protein and does not have a bitter taste. Whey protein is primarily found as whey protein concentrate or whey protein isolate. The one drawback with respect to whey protein concentrate or whey protein isolate is that it is not readily water or liquid soluble. Therefore, it must be combined with an emulsifier to promote instantization or solubility. One particular emulsifier of particular application is lecithin, which not only promotes the solubility of the whey protein powder, but also is rich in certain nutrients itself.

Lecithin is an excellent source of two B vitamins, Cholin and Inositol. If good health is to be maintained, particularly with the ingestion of fat, a larger intake of these two vitamins is required. Lecithin serves as an homogenizing and emulsifying agent capable of breaking the fat and cholesterol into tiny particles which can readily pass into the tissues. The richest sources of lecithin are natural oils such as soy oils, and the fat of egg yolk, liver and brains. The lecithin of choice heretofore with respect to combination with whey protein to promote solubility has been soy lecithin. Soy lecithin has several drawbacks, one of which is that it contains phytosterols which are estrogens and not particularly desirable in a protein drink. However, soy lecithin is easily extracted, and therefore less expensive than other lecithin sources. It is therefore the most prevalent lecithin used in combination with the whey protein powder.

Egg lecithin, rich in B vitamins, has not yet heretofore been used and combined with whey protein concentrate or whey protein isolate in order to provide a liquid soluble protein supplement drink due to processing difficulties. Applicant's method of production allows for whey protein concentrate or whey protein isolate to be combined with egg lecithin to form a liquid soluble protein supplement without inclusion of phytosterols present in soy lecithin.

### OBJECTS OF THE INVENTION

An object of the present invention is to provide for a whey protein supplement which is soluble in water and other liquids, and which is combined with egg lecithin.

A further object of the present invention is to provide for a novel protein drink in which whey protein concentrate or whey protein isolate is combined with the addition nutrient of egg lecithin to provide for a protein drink supplement.

A further object of the present invention is to provide for a novel protein drink in which whey protein concentrate or whey protein isolate is combined with egg lecithin to provide for a protein drink supplement which does not include phytosterols.

### SUMMARY OF THE INVENTION

A liquid soluble protein drink comprised of whey protein concentrate or whey protein isolate in combination with egg lecithin which results in a protein supplement wherein the whey protein concentrate is 80% protein and the whey protein isolate is 90% protein when combined with egg lecithin and eliminating phytosterols.

### BRIEF DESCRIPTION OF THE DRAWINGS

FIG. 1 is a schematic diagram of the method of manufacture.

### DETAILED DESCRIPTION OF THE INVENTION

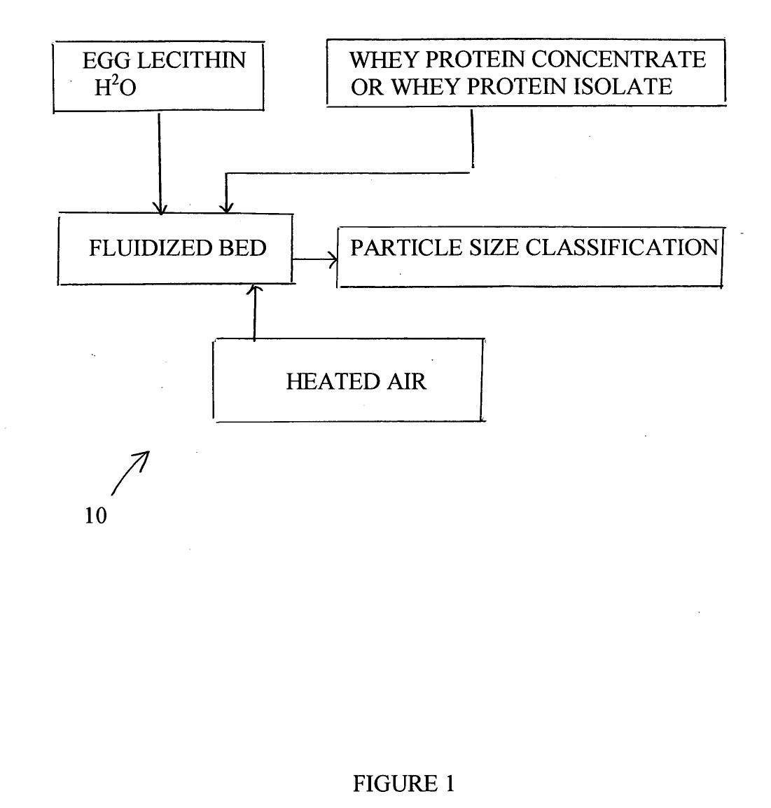

FIG. 1 is a schematic diagram of a flow chart for the preparation of an instantized whey protein concentrate/isolate utilizing egg lecithin.

In the first steps, the equipment to be utilized is sanitized and the necessary ingredients are released for use and weighed for the batch process. The batch process is carried out as an agglomeration process 10 which is a fluidized bed process. The inert material in the form of whey protein concentrate or whey protein isolate powders are fluidized in a stream of heated air. A fine mist of water in conjunction with egg lecithin is introduced into the fluidized bed. The combination of inert powders, egg lecithin and the water mist, causes the particulate matter to agglomerate or stick together, forming bonds. This is brought about by collision of the particles in the fluidized bed, and this random a process is continued until the desired particle size is achieved. Once the desired particle size is achieved, the water mist is discontinued and the heated air continues to dry the product in the fluidized bed until the desired moisture content is achieved. The finished product once fully dried is subject to particle size classification via a sieve process, after which it is tested to standards, and then packaged and shipped.

An example of a typical batch process in accordance with FIG. 1, approximately 400 pounds of whey protein concentrate or whey protein isolate would be introduced into the agglomeration process. To this would be added approximately 3 pounds of egg lecithin. The heated inlet air temperature for the agglomeration process would be between 180° F. and 200° F. in order to maintain an agglomeration temperature of between 110° F. and 120° F. The amount of water added with the egg lecithin may vary upon conditions, but it is designed to obtain a product moisture content that does not exceed ten to 12 percent. The product then is introduced into a drying chamber for a short period of time for drying in a range of between 125° F. and 135° F. after which it is subjected to a 20 mesh separation chamber.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A process for making a liquid soluble protein supplement formulated of either whey protein concentrate or whey protein isolate in combination with egg lecithin, the process comprising the steps:
(a) introducing whey protein concentrate or whey protein isolate, in dry powdered form into a fluidized bed of heated air;
(b) introducing egg lecithin into said fluidized bed in a stream of water mist;
(c) agglomerating said egg lecithin with said whey protein concentrate, or with said whey protein isolate, with said water mist in said fluidized bed until said desired particle size is achieved;
(d) discontinuing said stream of water mist once said desired particle size is achieved.
(e) continuing said flow of heated air into said fluidized bed until desired moisture content is achieved and product is dried; and
(f) undertaking particle size classification by means of the sieve process to obtain finalized product.

2. The process in accordance with claim 1 wherein said heated air introduced into said fluidized bed is in the range of between 180° F. and 200° F.

3. The process in accordance with claim 1 wherein the agglomeration temperature of said whey protein concentrate or said whey protein isolate, with said egg lecithin is in the range of between 110° F. and 120° F.

4. The process in accordance with claim 1 wherein said water mist added with said egg lecithin results in an agglomeration of said whey protein concentrate or said whey protein isolate, and said egg lecithin with a moisture content less than 12%.

5. The process in accordance with claim 4 wherein said moisture content is in the range of from 10% to 12%.

6. The process in accordance with claim 1 wherein said particle size classification is conducted in a 20 mesh separation chamber.

7. A liquid soluble protein supplement comprising a dry bonded agglomeration of whey protein concentrate or whey protein isolate in combination with egg lecithin and water moisture, wherein said water moisture is present in a range of from 10% to 12% and wherein said particle size of said dry, bonded agglomeration is 20 mesh.
